(19) United States
(12) Patent Application Publication
(10) Pub. No.: US 2017/0254441 A1
(43) Pub. Date: Sep. 7, 2017

(54) FLUID DISPENSING APPARATUS REGULATED BY A THROTTLE-LIKE HANDLE

(71) Applicant: Weston Rocco Furia, San Jose, CA (US)

(72) Inventor: Weston Rocco Furia, San Jose, CA (US)

(21) Appl. No.: 15/584,033

(22) Filed: May 2, 2017

Related U.S. Application Data
(60) Provisional application No. 62/389,560, filed on Mar. 3, 2016.

(51) Int. Cl. F16K 31/60; B67D 3/00

(52) U.S. Cl. CPC F16K 31/607; B67D 3/0058

(57) ABSTRACT

One embodiment of a fluid dispensing apparatus such as a beer bong or the type having a valve which is regulated by a throttle-like valve handle (66) that provides a mode of regulating the flow of fluid through a valve (64) with a twisting action that resembles the operation of a motorcycle throttle. Embodiments can offer an easy and recognizable mode of valve actuation, provide superior grip for easy control, or give the ability to install optional material around the valve handle that can change the look or feel of the handle. Other embodiments and advantages are described and shown.

### CROSS-REFERENCE TO RELATED APPLICATION

This application claims the benefit of U.S. Provisional Application No. 62/389,560, filed Mar. 3, 2016.

### TECHNICAL FIELD

The present invention relates to fluid dispensing apparatuses for gravitationally dispensing fluids for human consumption.

### BACKGROUND-PRIOR ART

| | | | |
|---|---|---|---|
| U.S. Pat. No. 3,216,627 | A | November 1965 | Best et al. |
| U.S. Pat. No. 7,185,788 | B2 | March 2007 | Morris |
| U.S. Pat. No. 7,784,361 | B2 | August 2010 | Wiedmann et al. |
| US20140076925 | A1 | July 2012 | J. Sodaro et al. |

Fluid dispensing apparatuses such as beer bongs or the type are typically used by persons to quickly consume various fluids. Although any beverage can be consumed with a beer bong, the preferred beverage to be consumed with a beer bong is beer.

Prior art can consist of a funnel connected to tubing. Prior art beer bongs consisting of a funnel and tubing do not offer users easy means to regulate the flow of fluid through it. The tubing needs to be folded or manually blocked in order to regulate the flow of fluid causing the prior art beer bong to be difficult to operate. Prior art consisting of a funnel and tubing are not very user friendly and are not very durable due to the continual folding and blocking of the tubing.

Prior art can also consist of a funnel, tubing, valve, or a plurality of each therein. In such prior art, the valve can be operated by the user to regulate the flow of fluid through the beer bong. The valve can be hand-operated by turning a valve-lever which is attached to the valve. The valve-levers found on such prior art are unfamiliar to most users and are often small in size which can cause the user difficulty. The small levers typically found on such prior art do not provide users with adequate surface area to grip and turn the knob which can make the use of such prior art frustrating. In addition, the rotational action required to operate said prior art valve-levers is not intuitive to most users.

### SUMMARY

In accordance with one embodiment, a fluid dispensing apparatus regulated by a throttle like handle comprises a fluid dispensing apparatus with a regulating valve that is controlled by the rotational motion of a throttle-like handle that resembles that of a motorcycle throttle.

### Advantages

Accordingly, several advantages of one or more aspects are as follows: to provide a mode of regulating a fluid dispensing apparatus valve with a twisting action that resembles that of a motorcycle throttle which can eliminate confusion associated with the regulation of prior art valves, offer a recognizable mode of valve actuation, provide superior grip for easy control, and give the ability to install optional material around the valve handle that can change the look or feel of the throttle-like valve handle. Other advantages of one or more aspects will be apparent from a consideration of the drawings and ensuing description.

### DRAWINGS-FIGURES

FIG. 1 is a perspective view of one embodiment with parts exploded

FIG. 2 is a detailed perspective view of the lower assembly of one embodiment with parts exploded

FIG. 3 is a perspective view of one embodiment with parts assembled

FIG. 4 is a detailed perspective view of the lower assembly of one embodiment with parts assembled

FIG. 5 is a side view of the lower assembly of one embodiment with parts assembled to show the rotational motion of the throttle-like valve handle

### DRAWINGS-REFERENCE NUMERALS

60 lower assembly
62 upper assembly
64 valve
66 throttle-like valve handle
68 valve handle attachment point
70 valve discharge opening
72 valve inlet opening
74 secondary transfer hose
76 secondary transfer hose discharge opening
78 secondary transfer hose inlet opening
80 main transfer hose
82 main transfer hose discharge opening
84 main transfer hose inlet opening
86 funnel
88 funnel inlet opening
90 funnel discharge opening
92 rotational motion
94 axis of rotation for the valve handle
96 center point for the axis of rotation for the valve handle

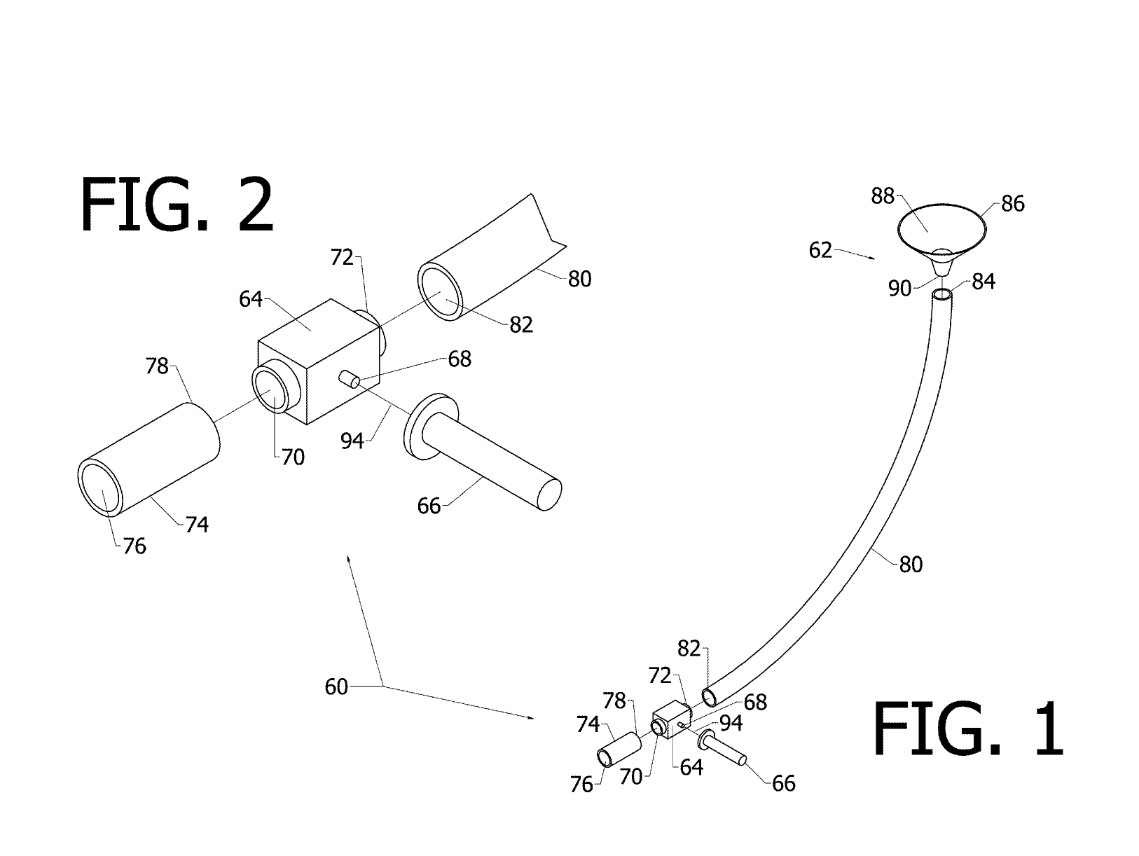

### DETAILED DESCRIPTION-FIGS. 1-5

FIGS. 1-5 show one embodiment of a fluid dispensing apparatus regulated by a throttle-like handle. The invention may have several embodiments and is not limited to the embodiment presented here.

As shown in the perspective view of one embodiment with parts exploded FIG. 1, a fluid dispensing apparatus regulated by a throttle-like handle can consist of an upper assembly 62 and a lower assembly 60. The upper assembly 62 of one embodiment can consist of a funnel 86 and a main transfer hose 80. The funnel 86 consists of a funnel inlet opening 88 and a funnel discharge opening 90 which can be attached to a main transfer hose 80 at the main transfer hose inlet opening 84.

The lower assembly 60 of one embodiment shown in FIG. 1 consists of a secondary fluid transfer hose 74, a valve 64, a throttle-like valve handle 66, and a main transfer hose 80. FIG. 2 shows a detailed perspective view of the lower assembly of one embodiment with parts exploded where a secondary transfer hose discharge opening 76 and a secondary transfer hose inlet opening 78 can be seen on the ends of the secondary transfer hose 74. The valve 64 can be seen in FIG. 2 with a valve discharge opening 70, a valve inlet opening 72, and a valve handle attachment point 68. A main transfer hose discharge opening 82 can be seen at the end of the main transfer hose 80 where the valve 64 is to be attached. FIG. 2 also shows the throttle-like valve handle 66 and an axis of rotation for valve handle 94 from which the throttle-like valve handle 66 is intended to rotate around.

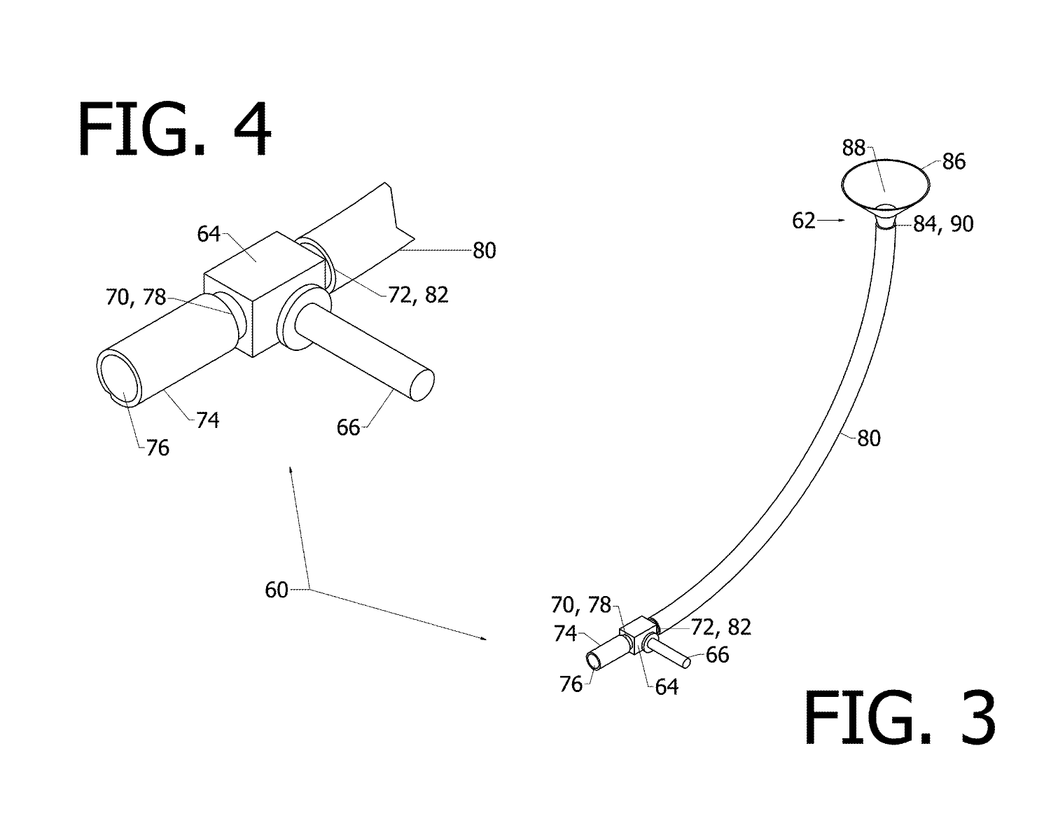

FIG. 3 provides a perspective view of one embodiment with parts assembled where both the upper assembly 62 and the lower assembly 60 are assembled to the show one embodiment in the form in which it is intended to be used. FIG. 3 shows the funnel 86 attached to the main transfer hose 80 by connecting the funnel discharge opening 90 to the main transfer hose inlet opening 84. The valve inlet opening 72 of the valve 64 can be attached to the main transfer hose discharge opening 82 of the main transfer hose 80 opposite of the funnel 86. The secondary fluid transfer hose 74 can be attached to the valve 64 by connecting the secondary transfer hose inlet opening 78 to the valve discharge opening 70. The throttle-like valve handle 66 is to be connected to the valve 64 at the valve handle attachment point 68. One embodiment can be assembled as seen in FIG. 3 where the secondary transfer hose discharge opening 76 and the funnel inlet opening 88 are opened to the atmosphere. Details of the attached components of the lower assembly 60 are shown more clearly in FIG. 4.

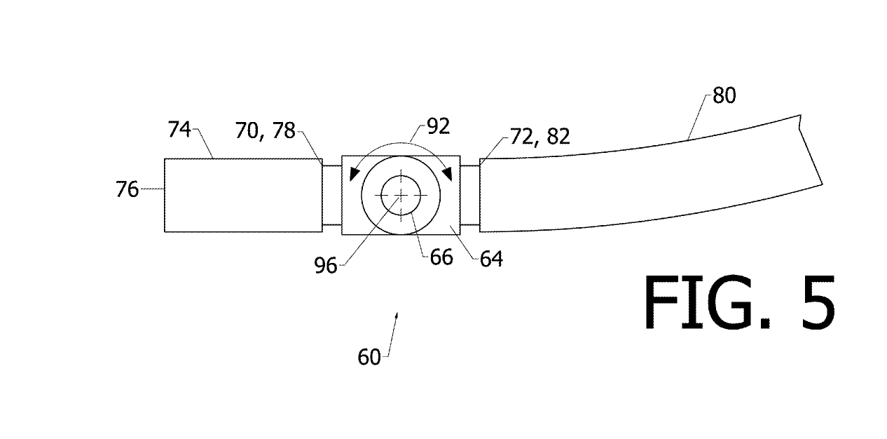

FIG. 5 provides a side view of the lower assembly of one embodiment with parts assembled to show the rotational motion of the throttle-like valve handle. The lower assembly 60 shown in FIG. 5 provides an arrow which represents the rotational motion 92 of the throttle-like valve handle 66 about the axis of rotation for the valve handle 94. FIG. 5 also shows a center point for the axis of rotation for the valve handle 96 from which the axis of rotation for the valve handle 94 can be located.

### OPERATION-FIGS. 1-5

The fluid dispensing apparatus regulated by a throttle-like handle allows the user to control the flow of fluid through the apparatus by rotating a throttle-like handle 66 resembling the action required to regulate a motorcycle throttle. To operate one embodiment, the user pours a beverage of their choice into the funnel inlet opening 88 of the funnel 86 where the fluid is quickly transfer by gravity to the main transfer hose 80 where it can be held until the user decides to operate the valve 64. He or she can then place their mouth to the secondary transfer hose discharge opening 76. When the user is ready to consume the fluid, they may operate one embodiment by gripping the throttle-like handle 66 with their hand and rotating it to execute the rotational motion 92 around the center point for the axis of rotation for the valve handle 96. This action may allow the fluid to flow through the main transfer hose 80, valve 64, secondary fluid transfer hose 76, and into the user's mouth for consumption. At anytime during operation, the user may regulate or stop the flow of the fluid through the valve 64 by rotating the throttle-like handle 66 around the center point for the axis of rotation for the valve handle 96.

From the description above, a number of advantages of some embodiments become evident:
A throttle-like valve handle requiring a twisting action that resembles that of a motorcycle throttle can offer a recognizable mode of valve regulation and actuation.
A throttle-like valve handle requiring a twisting action that resembles that of a motorcycle throttle can offer novel and enjoyable means of regulating the valve of a fluid dispensing apparatus
The use of a throttle-like valve handle provides superior grip for easy control.

### Conclusion, Ramifications, and Scope

Thus, the reader will see that one embodiment of a fluid dispensing apparatus regulated by a throttle-like handle can provide a mode of regulating a fluid dispensing apparatus valve with a twisting action that resembles that of a motorcycle throttle which can offer an easy and recognizable mode of valve actuation as well as provide superior grip for easy valve regulation.

Although the description above contains may specificities, these should not be construed as limiting the scope of the embodiments. The description above merely provides illustrations of one of several embodiments. For example, alternative embodiments may use a throttle-like valve handle that does not have a flange similar to that of the throttle-like valve handle 66 shown in FIGS. 1-5. Alternative embodiments may also include additional material or alternative finish around the throttle-like handle to provide the user with different gripping or visual characteristics, the use of a mechanism or spring to aid the rotation of the throttle-like valve handle, or a mechanism to limit the rotational range of the motorcycle throttle-like handle.

Additionally, there are various possibilities regarding the assembly of a fluid dispensing apparatus regulated by a throttle-like handle that may not comprise of a secondary fluid transfer hose, a funnel, or a main fluid transfer hose. Alternative embodiments can also be comprised of more than one secondary transfer hose, main transfer hose, funnel, valve, or throttle-like valve handle.

1. A fluid dispensing apparatus, comprising:
A valve with a throttle-like valve handle whereby a user rotates said throttle-like valve handle in a manner resembling the operation of a motorcycle throttle to regulate the flow of fluid through said fluid dispensing apparatus.
